(19) United States
(12) Patent Application Publication
(10) Pub. No.: US 2026/0024807 A1
(43) Pub. Date: Jan. 22, 2026

(54) ALL-INORGANIC SOLVENTS FOR ELECTROLYTES

(71) Applicant: New Dominion Enterprises, Inc., Austin, TX (US)

(72) Inventor: Mason K. Harrup, Idaho Falls, ID (US)

(21) Appl. No.: 19/032,058

(22) Filed: Jan. 19, 2025

Related U.S. Application Data
(63) Continuation of application No. 17/687,638, filed on Mar. 5, 2022.
Application No. 17/687,638 is a continuation of application No. 16/921,826, filed on Jul. 6, 2020, now Pat. No. 11,271,248.
Application No. 16/921,826 is a division of application No. 15/082,780, filed on Mar. 28, 2016, now Pat. No. 10,707,526.
(60) Provisional application No. 62/139,552, filed on Mar. 27, 2015.

(51) Int. Cl. H01M 10/0563; H01M 4/36; H01M 10/0525; H01M 10/056; H01M 10/42

(52) U.S. Cl. CPC H01M 10/0563; H01M 4/366; H01M 10/0525; H01M 10/056; H01M 10/4235; H01M 2300/002; H01M 2300/0094

(57) ABSTRACT

An all-inorganic electrolyte formulation for use in a lithium-ion battery system comprising at least one of each a phosphoranimine, a phosphazene, a monomeric organophosphate and a supporting lithium salt. The electrolyte preferably has a melting point below 0° C., and a vapor pressure of combustible components at 60.6° C. sufficiently low to not produce a combustible mixture in air, e.g., less than 40 mmHg at 30° C. The phosphoranimine, phosphazene, and monomeric phosphorus compound preferably do not have any direct halogen-phosphorus bonds. A solid electrolyte interface layer formed by the electrolyte with an electrode is preferably thermally stable ≥80° C.

### CROSS REFERENCE TO RELATED APPLICATIONS

The present application is a Continuation of U.S. patent application Ser. No. 17/687,638, filed Mar. 5, 2022, now pending, which is a Continuation of U.S. patent application Ser. No. 16/921,826, filed Jul. 6, 2020, now U.S. Pat. No. 11,271,248, issued Mar. 8, 2022, which is a Division of U.S. patent application Ser. No. 15/082,780, filed Mar. 28, 2016, now U.S. Pat. No. 10,707,526, issued Jul. 7, 2020, which is a non-provisional of, and claims benefit of priority under 35 U.S.C. § 119(e) from, U.S. Provisional Patent Application No. 62/139,552, filed Mar. 27, 2015, the entirety of which are expressly incorporated herein by reference in their entirety.

### FIELD OF THE INVENTION

The present invention relates to a solvent system comprising a mixture of primary solvent phosphoranimine (PA) derivatives, and co-solvents comprised of cyclotriphosphazene (Pz) derivatives optionally with monomeric phosphorus (MP) compound additives, for the potentially complete replacement of organic solvents in an electrolyte formulation. A preferred application is in lithium-ion batteries.

### BACKGROUND OF THE INVENTION

Batteries with high activity metals, i.e., cell potentials above about 1.5 V, are subject to hydrolysis of aqueous electrolytes. Therefore, rechargeable high energy batteries typically employ non-aqueous electrolytes which lack free hydroxyl substituents. Other criteria for suitable electrolytes are solubility for a supporting salt which yields a charge carrier ion in sufficient concentration to permit high current density, while avoiding strongly bound complexes of the charge carrier ion with the solvent, and a sufficiently low viscosity to permit efficient charge carrier transport through the electrolyte. Further, the battery typically has a storage temperature range of 0° C. or below to 60° C. or above, and the electrolyte should be reasonably stable as a liquid within that range. Finally, the electrolyte should be chemically inert with respect to the battery chemistry, with the exception of the formation of a stable solid electrolyte interphase (SEI) layer near the reactive surface of the electrode, which permits flow of the charge carrier ions between the bulk electrolyte solution and the electrode surfaces, while protecting the bulk electrolyte solution from large-scale decomposition by the electrochemical reactions that during cycling. The SEI should be dynamic, and reform as required under normal battery cycling conditions from the bulk electrolyte solution.

Lithium-ion batteries have been in widespread use for decades. These energy storage systems have been investigated for a wide variety of applications, from small single cell platforms, such as watches, phones and the like; to larger format platforms such as those applicable for transportation systems and potentially grid-scale energy storage. A considerable limitation of lithium-ion batteries containing lithium salts in organic solvents, such as ethylene carbonate and ethyl methyl carbonate, is the potential for the ignition of the flammable electrolyte solution under certain operating conditions. Also notable is the degradation of the solvent and the formation of the SEI under current draw that can raise the temperature and hence the internal pressure generated causing the battery cell to rupture. Multiple approaches to effect the replacement of organic solvents from battery electrolytes have been investigated over the past 20+ years. Some have limiting requirements that make them impractical for wide-scale adoption for common multi-cell applications, such as thermal requirements (molten salts) and complex engineering designs (flow batteries). There is a pressing need for a complete replacement of current organic electrolyte systems without these constraints. One area that has shown promise of fulfilling these stringent requirements is through the use of phosphorus-based inorganic compounds. The present invention leverages compounds of this nature to achieve the goal of eliminating all organic components from the electrolyte system for a wide variety of lithium-ion-based energy storage platforms.

Most of the commercial electrolytes for lithium-ion batteries are LiPF₆ dissolved in a mixture of organic carbonate and/or ester solvents. These electrolyte blends are highly volatile and highly flammable, with typical flash points as low as 30° C. or less. This presents serious safety concerns especially when utilized in large format cells or when the cells come under undo stress or physical damage. One approach to improve the safety performance of the electrolyte is to use additives and co-solvents to reduce the flammability of the organic carbonate and ester electrolytes. A variety of additives and co-solvents have been proposed, including sulfones, ionic liquids, phosphates, phospholanes, Pzs, siloxanes, fluorinated carbonates, and fluorinated ethers and mixtures thereof. In addition to flammability suppression, additives have also been used to improve SEI formation, overcharge protection, and thermal stability.

Electrolyte solutions used in lithium-ion batteries are known to be unstable at high temperatures and high voltages. Over time, the organic electrolyte solution turns into a tar-like material at high temperatures. The electrolyte solutions may include carbonate-based solvents, such as dimethyl carbonate (DMC), ethylene carbonate (EC), ethylmethyl carbonate (EMC), etc. However, the carbonate-based solvents are problematic due to their high volatility, flammability, and decomposition at even modestly elevated temperatures, such as low as 60° C.

The lithium metal anode provides a very high capacity and the lowest potential of all metallic anode materials. Therefore, it is not only used in commercial primary lithium metal batteries, but is also proposed as an anode material in rechargeable lithium/air and lithium/sulfur batteries, which are considered as super-high specific energy accumulators of tomorrow. These high energy batteries are urgently demanded to meet a longer driving range in electric vehicles (electro-mobility). However, the rechargeable lithium metal anode suffers from poor rechargeability and low safety. Due to the low potential, the electrolytes traditionally used are thermodynamically not stable against lithium. Their reductive decomposition and the parallel corrosion of the Li electrode lead to the formation of the SEI. This passivating film is supposed to slow down or in the ideal case even prevent electrolyte decomposition. In addition, heterogeneous lithium deposition and dissolution during charge and discharge of the lithium metal anode eventually leads to high surface area lithium, commonly called lithium dendrites in most of the organic solvent-based electrolytes. This may cause a loss of active material due to enhanced lithium corrosion at the high surface area Li, as well as due to the disconnection of dendrites from electronic contact. In addition, short-circuit of the cell may happen when the dendrites grow across the electrolyte to the cathode. In any case, the continuous creation of new lithium surfaces by dendrite formation leads to continuous electrolyte decomposition during cycling.

Overpotentials are generated by kinetic hindrances in the system. In lithium plating and stripping processes, these may include the lithium-ion transport in the electrolyte and in the electrode/electrolyte interphase, such as the SEI, and always the kinetic hindrance of the lithium-ion reduction and oxidation processes at the electrode itself, influencing the charge transfer resistance.

To reduce the flammability of the electrolyte solution, organophosphorus compounds, such as phosphates and cyclic Pzs, have been investigated as an additive or co-solvent to the electrolyte solution. PA compounds, which include a phosphorus-nitrogen double bond, and additional substituents on the phosphorus and nitrogen, are known in the art as synthetic intermediates in the formation of polyphosphazene compounds or cyclic Pz compounds. PA compounds have been disclosed for use in positive electrodes of lithium primary cells and for use in electrolyte solutions in combination with an aprotic organic solvent. See Wu et al., “An Electrochemically Compatible and Flame-Retardant Electrolyte Additive for Safe Lithium-ion Batteries”, J. Power Sources 227 (2013) 106-110, expressly incorporated herein by reference in its entirety, which discusses a phosphazenic compound as an electrolyte additive. The phosphazenic compound was triethoxyphosphazen-N-phosphoryldiethylester (PNP), which included a phosphine oxide functional group bonded to a nitrogen atom of the phosphazenic compound. The electrochemical characterization of the PNP-containing electrolyte was tested in MCMB/Li half-cells at 0% loading, 10% loading, 20% loading, 50% loading, and pure PNP, showing a 20% decrease in capacity at 20% loading. At 10% loading, there was little observed difference when compared to traditional electrolytes. However, loadings in excess of 20%, for example, at 50% and 100%, were not able to cycle effectively.

US 2015340739 (Klaehn et al.), expressly incorporated herein by reference in its entirety, discloses an electrolyte solution comprising at least one PA compound and a metal salt. The at least one PA compound comprises a compound of the chemical structure X—N═P(R¹, R², R³), where X is an organosilyl group (e.g., trimethyl silyl), an alkyl group, or an aryl group (e.g., a tert-butyl group) and each of R¹, R², and R³ is independently selected from the group consisting of an alkyl group, an aryl group, an alkoxy group, or an aryloxy group, or a sulfur or nitrogen analogue thereof. The PA compound is an acyclic (e.g., linear) compound that includes a double bond between a phosphorus atom and a nitrogen atom of the PA compound. Three pendant groups are bonded to the phosphorus atom, and a pendant group is bonded to the nitrogen atom. The PA compound is a monomeric Pz compound. A cationic pendant group may also be used as at least one of R¹, R², and R³. The choice of functional group (X) bonded to the nitrogen atom may be more limited by synthetic chemistry techniques than is the choice of functional group bonded to the phosphorus atom. The pendant groups on each of the phosphorus atom and the nitrogen atom may be the same as, or different from, one another. The PA compound should not include a halogen directly bonded to the phosphorus for stability. However, a halogen may otherwise be a substituent.

See, U.S. Pat. Nos. 4,248,868; 4,613,676; 4,719,288; 4,722,877; 4,727,060; 4,772,433; 4,810,599; 4,828,945; 4,863,903; 4,931,591; 4,985,317; 5,041,346; 5,061,581; 5,110,694; 5,114,809; 5,153,080; 5,153,082; 5,176,969; 5,180,645; 5,188,783; 5,190,695; 5,337,184; 5,420,000; 5,426,005; 5,443,601; 5,474,860; 5,548,055; 5,567,783; 5,576,120; 5,591,545; 5,633,098; 5,660,948; 5,672,446; 5,672,465; 5,698,338; 5,700,298; 5,707,760; 5,725,968; 5,728,489; 5,731,104; 5,744,264; 5,753,388; 5,756,231; 5,780,182; 5,783,333; 5,786,110; 5,789,110; 5,824,434; 5,843,592; 5,851,504; 5,912,093; 5,962,169; 5,998,559; 6,007,947; 6,013,393; 6,015,638; 6,087,426; 6,096,453; 6,103,419; 6,103,426; 6,168,885; 6,207,326; 6,316,149; 6,379,842; 6,391,492; 6,395,423; 6,413,675; 6,413,676; 6,416,905; 6,444,370; 6,447,952; 6,472,104; 6,475,679; 6,475,680; 6,492,449; 6,599,664; 6,605,237; 6,645,675; 6,664,006; 6,699,623; 6,721,168; 6,759,164; 6,759,460; 6,797,019; 6,815,119; 6,828,065; 6,841,301; 6,893,774; 6,908,186; 6,955,867; 7,005,206; 7,008,564; 7,052,805; 7,060,744; 7,067,219; 7,077,516; 7,081,320; 7,084,290; 7,091,266; 7,094,501; 7,099,142; 7,118,694; 7,226,702; 7,229,719; 7,238,450; 7,247,740; 7,273,597; 7,285,362; 7,316,855; 7,378,193; 7,410,731; 7,429,433; 7,473,491; 7,494,745; 7,498,102; 7,524,439; 7,557,637; 7,560,595; 7,579,118; 7,582,380; 7,585,587; 7,585,994; 7,588,859; 7,598,002; 7,656,125; 7,678,505; 7,695,860; 7,695,862; 7,713,449; 7,718,321; 7,718,826; 7,759,418; 7,781,105; 7,811,707; 7,811,708; 7,820,328; 7,824,800; 7,828,728; 7,838,143; 7,851,090; 7,875,204; 7,875,393; 7,939,199; 7,939,206; 7,951,495; 7,976,983; 7,977,393; 7,989,109; 8,000,084; 8,003,241; 8,003,256; 8,012,615; 8,030,500; 8,034,491; 8,048,569; 8,062,796; 8,071,233; 8,076,031; 8,076,032; 8,084,998; 8,092,940; 8,119,038; 8,124,269; 8,133,614; 8,137,844; 8,153,307; 8,168,330; 8,168,831; 8,178,009; 8,187,749; 8,211,336; 8,221,915; 8,227,103; 8,236,449; 8,257,866; 8,257,870; 8,263,697; 8,268,197; 8,287,483; 8,301,322; 8,308,971; 8,309,240; 8,357,450; 8,367,755; 8,377,596; 8,384,058; 8,415,045; 8,420,266; 8,450,012; 8,455,141; 8,465,871; 8,470,472; 8,486,560; 8,486,565; 8,512,896; 8,512,899; 8,524,399; 8,556,996; 8,562,873; 8,574,773; 8,579,994; 8,592,081; 8,597,815; 8,597,827; 8,628,873; 8,652,688; 8,658,062; 8,669,114; 8,673,499; 8,679,670; 8,679,684; 8,686,074; 8,703,310; 8,703,344; 8,715,863; 8,728,170; 8,734,668; 8,734,674; 8,734,988; 8,741,486; 8,754,138; 8,765,295; 8,778,533; 8,785,022; 8,795,886; 8,795,903; 8,801,810; 8,802,285; 8,814,956; 8,815,432; 8,822,084; 8,822,088; 8,828,605; 8,841,035; 8,845,764; 8,846,249; 8,846,251; 8,846,922; 8,852,801; 8,852,813; 8,870,810; 8,871,385; 8,889,301; 8,900,754; 8,906,549; 8,922,959; 8,927,127; 8,945,774; 8,974,947; 8,986,881; 8,999,009; 9,012,093; 9,012,094; 9,077,037; 9,077,046; 9,093,716; 9,099,252; 9,099,756; 9,105,908; 9,105,942; 9,111,684; 9,112,212; 9,118,088; 9,123,973; 9,130,214; 9,130,245; 9,142,357; 9,147,906; 9,166,206; 9,166,222; 9,166,249; 9,172,076; 9,172,088; 9,172,094; 9,183,995; 9,184,467; 9,184,468; 9,190,616; 9,190,695; 9,190,698; 9,196,926; 9,203,084; 9,203,107; 9,203,113; 9,206,210; 9,207,513; 9,209,456; 9,214,659; 9,219,274; 9,227,850; 9,230,746; 9,231,243; 9,236,634; 9,236,635; 9,240,614; 9,246,150; 9,252,399; 9,257,720; 9,263,731; 9,263,764; 9,273,399; 9,281,541; 9,281,543; 9,284,324; 9,287,560; 9,293,749; 9,293,787; 9,293,796; RE37076; 20010004506; 20010004507; 20010012590; 20020014616; 20020031701; 20020039275; 20020048706; 20020055047; 20020076611; 20020085968; 20020090331; 20020090547; 20020094311; 20020098135; 20020100725; 20020102196; 20020110739; 20020122979; 20020127162; 20020127169; 20020127454; 20020128364; 20020136681; 20020136683; 20020150524; 20020155353; 20020159943; 20020160270; 20020182488; 20020185627; 20020193533; 20020197522; 20020197531; 20030003369; 20030059683; 20030068555; 20030091904; 20030108801; 20030113635; 20030125437; 20030129500; 20030148191; 20030170548; 20030175597; 20030175598; 20030190531; 20030198868; 20040009404; 20040013927; 20040039134; 20040053138; 20040085710; 20040126305; 20040126658; 20040126659; 20040139587; 20040142246; 20040146778; 20040146786; 20040151985; 20040157122; 20040158091; 20040170901; 20040189762; 20040189763; 20040191635; 20040192853; 20040220348; 20050008938; 20050042503; 20050085655; 20050095197; 20050095504; 20050106458; 20050106460; 20050123836; 20050136329; 20050153207; 20050158626; 20050164093; 20050175529; 20050175904; 20050181280; 20050214700; 20050215764; 20050221168; 20050228087; 20050249656; 20050249667; 20050255385; 20050260120; 20050272214; 20060032046; 20060034943; 20060035137; 20060046151; 20060073381; 20060121355; 20060147371; 20060147807; 20060154144; 20060154147; 20060166098; 20060172200; 20060180796; 20060194119; 20060204856; 20060210873; 20060210883; 20060217568; 20060269834; 20060281010; 20060281011; 20060292451; 20070020529; 20070026315; 20070027129; 20070029972; 20070037046; 20070037063; 20070040154; 20070043158; 20070048209; 20070048596; 20070048622; 20070048623; 20070054180; 20070077496; 20070092549; 20070117007; 20070141470; 20070149496; 20070166617; 20070172740; 20070180688; 20070182418; 20070183954; 20070207384; 20070212615; 20070216469; 20070243470; 20070298314; 20080008928; 20080008933; 20080020276; 20080020285; 20080044736; 20080051495; 20080063585; 20080063588; 20080075999; 20080089830; 20080096056; 20080099734; 20080107586; 20080118428; 20080118843; 20080119421; 20080138700; 20080152996; 20080153005; 20080160417; 20080164444; 20080171268; 20080176141; 20080193840; 20080193848; 20080213588; 20080213661; 20080224100; 20080233477; 20080241693; 20080241699; 20080254361; 20080261116; 20080269492; 20080311025; 20090004094; 20090005824; 20090011340; 20090017364; 20090023071; 20090027827; 20090029138; 20090029193; 20090035656; 20090075176; 20090081547; 20090081548; 20090104523; 20090123813; 20090130567; 20090136854; 20090155696; 20090155697; 20090169463; 20090181296; 20090186267; 20090191464; 20090208835; 20090246625; 20090246628; 20090253035; 20090253046; 20090256528; 20090259420; 20090269654; 20090269673; 20090280400; 20090291330; 20090297937; 20090305016; 20090311587; 20100009260; 20100015521; 20100018034; 20100047695; 20100062345; 20100068461; 20100068605; 20100075222; 20100075225; 20100078599; 20100086823; 20100090650; 20100119881; 20100119956; 20100124691; 20100125082; 20100125087; 20100136410; 20100143770; 20100159346; 20100164436; 20100167121; 20100173139; 20100178555; 20100183917; 20100190059; 20100200403; 20100209782; 20100216016; 20100216027; 20100224824; 20100233523; 20100240813; 20100255356; 20100279155; 20100285352; 20100285354; 20100285358; 20100285373; 20100297502; 20100299008; 20100304205; 20100304223; 20100310941; 20100323238; 20100330410; 20100330419; 20100330421; 20100330423; 20100330425; 20110014527; 20110020704; 20110020706; 20110024396; 20110027656; 20110033734; 20110033756; 20110039157; 20110049745; 20110052966; 20110059349; 20110067230; 20110070495; 20110070504; 20110077880; 20110081563; 20110081581; 20110086781; 20110097628; 20110097630; 20110098463; 20110104553; 20110104565; 20110111294; 20110111304; 20110117407; 20110117445; 20110117446; 20110123869; 20110136019; 20110143201; 20110143219; 20110159329; 20110159365; 20110159377; 20110159379; 20110171502; 20110177393; 20110181249; 20110183216; 20110189512; 20110189520; 20110189548; 20110189579; 20110195318; 20110200874; 20110206979; 20110206994; 20110207000; 20110229761; 20110236751; 20110236765; 20110250503; 20110256457; 20110264381; 20110274977; 20110287316; 20110287318; 20110293997; 20110301931; 20110305949; 20110305958; 20110319426; 20120003514; 20120003518; 20120007560; 20120015249; 20120021286; 20120028105; 20120034512; 20120045670; 20120052401; 20120058377; 20120060360; 20120064396; 20120070741; 20120077076; 20120077082; 20120082873; 20120082890; 20120082902; 20120082903; 20120088155; 20120088162; 20120094178; 20120100438; 20120105007; 20120107680; 20120107697; 20120107726; 20120115018; 20120121974; 20120121989; 20120121991; 20120129019; 20120129046; 20120133341; 20120135312; 20120141864; 20120141866; 20120141867; 20120141869; 20120141878; 20120141883; 20120141884; 20120148922; 20120155507; 20120164519; 20120164541; 20120169297; 20120171536; 20120171542; 20120175552; 20120177995; 20120183842; 20120183843; 20120183856; 20120183865; 20120183866; 20120188086; 20120189920; 20120202112; 20120208087; 20120218683; 20120219865; 20120225331; 20120225358; 20120225359; 20120231308; 20120231325; 20120231352; 20120244391; 20120244417; 20120251886; 20120251892; 20120273737; 20120276445; 20120288750; 20120288751; 20120288769; 20120289887; 20120293916; 20120295155; 20120295165; 20120301789; 20120301797; 20120308894; 20120315535; 20120315549; 20120321959; 20120328942; 20120328952; 20130004839; 20130004862; 20130011728; 20130011736; 20130017443; 20130017453; 20130022863; 20130022880; 20130026409; 20130040203; 20130043843; 20130048923; 20130052528; 20130052542; 20130055559; 20130059172; 20130065122; 20130065130; 20130069601; 20130069658; 20130069661; 20130071733; 20130071739; 20130071762; 20130072154; 20130078525; 20130084495; 20130084496; 20130084501; 20130088204; 20130089793; 20130090900; 20130092866; 20130095351; 20130095392; 20130100563; 20130108899; 20130108930; 20130115520; 20130115529; 20130130069; 20130130121; 20130130128; 20130135110; 20130136981; 20130143090; 20130143129; 20130149567; 20130149602; 20130149605; 20130157147; 20130157149; 20130157152; 20130163148; 20130164611; 20130164612; 20130169238; 20130171340; 20130171502; 20130171512; 20130177814; 20130183579; 20130183580; 20130189575; 20130189579; 20130195805; 20130196223; 20130196235; 20130199936; 20130202920; 20130202955; 20130202956; 20130202959; 20130202967; 20130202973; 20130209860; 20130209869; 20130209870; 20130209887; 20130209897; 20130216899; 20130216907; 20130216908; 20130216918; 20130216920; 20130224576; 20130224583; 20130230772; 20130230773; 20130230779; 20130232772; 20130234074; 20130236750; 20130236766; 20130244102; 20130244107; 20130252090; 20130252101; 20130260222; 20130260229; 20130260232; 20130260254; 20130260255; 20130264999; 20130266827; 20130266846; 20130266858; 20130266866; 20130271089; 20130277599; 20130280592; 20130280621; 20130288084; 20130288113; 20130288120; 20130288138; 20130295439; 20130295461; 20130295465; 20130295492; 20130302650; 20130302679; 20130302697; 20130302702; 20130309527; 20130309549; 20130309564; 20130309571; 20130316248; 20130319870; 20130320582; 20130323585; 20130323595; 20130323605; 20130327648; 20130330609; 20130330637; 20130337304; 20130337335; 20130337338; 20130337339; 20130337340; 20130337341; 20130337343; 20130337346; 20130344360; 20130344383; 20130344391; 20130344392; 20140011081; 20140011088; 20140015160; 20140017549; 20140017559; 20140017568; 20140017573; 20140023932; 20140023934; 20140030609; 20140030610; 20140030623; 20140038059; 20140038060; 20140045015; 20140045016; 20140045017; 20140045019; 20140045020; 20140045021; 20140045022; 20140045065; 20140050910; 20140050972; 20140057168; 20140057169; 20140057172; 20140057173; 20140057179; 20140065479; 20140072837; 20140072843; 20140072877; 20140087214; 20140087250; 20140087251; 20140087257; 20140093780; 20140093787; 20140099560; 20140106219; 20140107326; 20140113202; 20140113203; 20140117940; 20140125292; 20140127567; 20140127575; 20140132220; 20140134499; 20140134501; 20140134521; 20140138591; 20140141336; 20140141337; 20140141340; 20140147741; 20140147752; 20140154546; 20140154557; 20140154559; 20140154587; 20140154590; 20140162130; 20140162131; 20140166929; 20140166939; 20140170303; 20140170475; 20140170482; 20140170498; 20140170503; 20140170524; 20140173300; 20140176074; 20140176076; 20140178759; 20140178770; 20140178772; 20140184162; 20140184172; 20140193712; 20140197801; 20140197805; 20140199585; 20140199599; 20140199600; 20140205905; 20140212752; 20140212763; 20140212770; 20140220417; 20140220422; 20140227432; 20140230887; 20140234693; 20140234705; 20140234711; 20140234712; 20140234713; 20140234727; 20140234732; 20140242445; 20140242453; 20140242469; 20140242474; 20140248521; 20140248537; 20140264198; 20140266075; 20140272132; 20140272489; 20140272531; 20140272553; 20140272558; 20140272567; 20140272568; 20140272574; 20140272576; 20140272577; 20140272578; 20140272579; 20140272580; 20140272583; 20140272591; 20140287305; 20140287325; 20140287330; 20140295268; 20140295270; 20140295290; 20140302354; 20140302400; 20140308562; 20140308583; 20140308585; 20140308588; 20140310951; 20140312269; 20140314948; 20140315072; 20140315097; 20140322579; 20140322602; 20140329120; 20140329131; 20140329150; 20140335406; 20140335410; 20140335411; 20140342200; 20140342228; 20140342240; 20140346618; 20140349182; 20140349186; 20140356708; 20140356735; 20140363735; 20140363746; 20140370380; 20140370387; 20140376160; 20140377635; 20140377667; 20140377668; 20150002162; 20150004444; 20150004480; 20150004482; 20150004488; 20150004495; 20150010460; 20150010784; 20150017541; 20150017543; 20150024279; 20150030856; 20150030939; 20150037675; 20150037686; 20150037690; 20150044517; 20150044533; 20150044556; 20150044571; 20150044573; 20150050535; 20150050564; 20150050565; 20150056488; 20150056507; 20150056509; 20150056514; 20150056516; 20150062687; 20150064568; 20150064578; 20150064580; 20150069307; 20150072225; 20150072232; 20150072247; 20150079477; 20150079483; 20150079484; 20150086876; 20150086877; 20150089797; 20150093631; 20150093647; 20150093653; 20150099165; 20150099184; 20150099185; 20150099187; 20150099191; 20150099192; 20150102257; 20150104701; 20150104712; 20150104716; 20150111078; 20150111099; 20150118558; 20150118565; 20150118572; 20150125595; 20150125752; 20150125759; 20150125761; 20150137030; 20150140206; 20150140427; 20150140434; 20150140446; 20150147624; 20150147642; 20150147645; 20150147662; 20150152566; 20150155546; 20150155557; 20150162139; 20150162588; 20150162603; 20150171414; 20150171426; 20150179976; 20150180001; 20150180023; 20150180087; 20150180249; 20150188125; 20150188191; 20150191841; 20150194702; 20150200390; 20150200422; 20150207147; 20150207174; 20150207176; 20150210044; 20150214529; 20150214573; 20150214577; 20150221936; 20150221983; 20150221987; 20150228980; 20150236343; 20150236372; 20150236378; 20150236380; 20150243972; 20150243973; 20150243987; 20150243988; 20150244041; 20150249247; 20150249262; 20150263342; 20150263379; 20150263543; 20150270552; 20150270573; 20150280219; 20150280229; 20150280267; 20150288031; 20150295241; 20150295275; 20150295276; 20150303481; 20150311509; 20150311525; 20150311564; 20150318543; 20150318570; 20150318572; 20150318578; 20150318580; 20150325843; 20150325852; 20150325880; 20150325882; 20150325884; 20150333310; 20150333315; 20150333370; 20150340679; 20150340739; 20150349338; 20150357646; 20150364747; 20150364748; 20150364755; 20150364791; 20150364794; 20150364795; 20150364796; 20150372296; 20150372305; 20150372346; 20150372349; 20150373831; 20150377977; 20150380355; 20150380731; 20150380772; 20150380777; each of which is expressly incorporated herein by reference in its entirety.

### SUMMARY OF THE INVENTION

The present technology includes the use of an all-inorganic electrolyte system suitable for a wide variety of energy storage systems, especially lithium-ion chemistry. The key composition of the solvent system provides a combination of two distinct classes of phosphorus compounds; PA and Pz, in an electrolyte system which substantially excludes (e.g., <2% by weight) organic carbonates. Each class of phosphorus-based compounds has both benefits and limitations alone. Yet, each of the sets of limitations can be designed in such a fashion as to retain the beneficial properties of each distinct class, while simultaneously significantly reducing or altogether eliminating the limitations of either class alone. Preferably, a MP compound, e.g., a phosphate, phosphonate, phosphinate, phosphine or phosphine oxide, with substituents that are generally non-reactive with the battery chemistry and stable under battery operational conditions, is provided in the electrolyte system as well.

The inorganic solvent system can greatly improve lithium-ion batteries by better controlling the issues of volatility, flammability, and thermal and electrochemical instability inherent to organic solvents that lead to significant cell degradation and catastrophic failure. Additionally, the PA/Pz solvent system has improved performance pertaining to the aforementioned issues as they relate to the bulk electrolyte solution and the SEI. The SEI formed in the PA/Pz system in a lithium-ion battery is believed to be breakdown products of the PA and Pz (and also the MP, if present), i.e., rich in phosphorus-nitrogen compounds, which may be largely inorganic, even if the substituents of the PA, Pz, or MP include organic ligands. This SEI is believed to be distinct from the SEI formed using other electrolyte chemistries. Note that the SEI at the anode and cathode will differ, due to the relative preponderance of oxidative and reductive processes at each. Therefore, it is preferred that a stable SEI form from the electrolyte components at all electrochemically active regions of the battery, or other energy storage device. When the electrolyte is used in other types of devices, the formation and criticality of an SEI is dependent on the characteristics of the respective electrochemical system.

The SEI acts to prevent direct contact of the electrolyte molecules with the surface of the electrode, while allowing charge carrier transport. Because the surface of the electrodes is dynamic, a small portion of the SEI redevelops during each charge/discharge cycle from the electrolyte components in contact with the electrode interface with the bulk electrolyte. The cathode also has an SEI, though the cathode surface is less dynamic than the anode. Therefore, the electrolyte medium itself is involved in electrochemical reactions with the electrodes, and should be selected to provide stability under such conditions. It is noted that the difficult-to-characterize chemical makeup of the SEI formed from the PA and Pz is an efficient free radical quencher, and thus once formed, provides an effective barrier that protects the bulk electrolyte from continuous degradation.

See, Sazhin, Sergiy V., Mason K. Harrup, and Kevin L. Gering. “Characterization of low-flammability electrolytes for lithium-ion batteries.” Journal of Power Sources 196.7 (2011): 3433-3438; Harrup, Mason K., et al. “Unsaturated phosphazenes as co-solvents for lithium-ion battery electrolytes.” Journal of Power Sources 278 (2015): 794-801; Xu, Kang, et al. “An attempt to formulate nonflammable lithium-ion electrolytes with alkyl phosphates and phosphazenes.” Journal of The Electrochemical Society 149.5 (2002): A622-A626; Gering, Kevin L., et al. Section IV. D. 3 for DOE 2013 Annual Report: Novel Phosphazene-Based Compounds to Enhance Safety and Stability of Cell Chemistries for High Voltage Applications (INL). No. INL/EXT-13-30529. Idaho National Laboratory (INL), 2013; Rollins, Harry W., et al. “Fluorinated phosphazene co-solvents for improved thermal and safety performance in lithium-ion battery electrolytes.” Journal of Power Sources 263 (2014): 66-74; Choi, Ji-Ae, Yongku Kang, and Dong-Won Kim. “Lithium polymer cell assembled by in situ chemical cross-linking of ionic liquid electrolyte with phosphazene-based cross-linking agent.” Electrochimica Acta 89 (2013): 359-364; Gering, Kevin, M. Harrup, and E. Dufek. “Integrated Carbon-Reduced Battery Chemistries for Safer Alternative Li-Ion Cells.” 224th ECS Meeting (Oct. 27-Nov. 1, 2013). Ecs, 2013; Harrup, Mason, Eric J. Dufek, and Kevin L. Gering. “Integrated Carbon-Reduced Battery Chemistries for Safer Alternative Li-Ion Cells.” Meeting Abstracts. No. 14. The Electrochemical Society, 2013; Bieker, Georg, Martin Winter, and Peter Bieker. “Electrochemical in situ investigations of SEI and dendrite formation on the lithium metal anode.” Physical Chemistry Chemical Physics 17.14 (2015): 8670-8679; Harrup, Mason K., et al. “Unsaturated phosphazenes as co-solvents for lithium-ion battery electrolytes.” Journal of Power Sources 278 (2015): 794-801; Wu, Bingbin, et al. “An electrochemically compatible and flame-retardant electrolyte additive for safe lithium ion batteries.” Journal of Power Sources 227 (2013): 106-110; Harrup, Mason K., et al. “Phosphazene Based Additives for Improvement of Safety and Battery Lifetimes in Lithium-Ion Batteries.” ECS Transactions 41.39 (2012): 13-25; Zhang, Qing, et al. “Improved thermal stability of LiCoO2 by cyclotriphosphazene additives in lithium-ion batteries.” Chemistry Letters 34.7 (2005): 1012-1013; Benson, Michael T., Mason K. Harrup, and Kevin L. Gering. “Lithium binding in fluorinated phosphazene trimers.” Computational and Theoretical Chemistry 1005 (2013): 25-34; Zhang, Sheng Shui. “A review on electrolyte additives for lithium-ion batteries.” Journal of Power Sources 162.2 (2006): 1379-1394; Cao, Xia, et al. “Novel phosphamide additive to improve thermal stability of solid electrolyte interphase on graphite anode in lithium-ion batteries.” ACS applied materials & interfaces 5.22 (2013): 11494-11497., each of which is expressly incorporated herein by reference in its entirety. See also U.S. Pat. Nos. 6,146,787; 6,544,690; 6,723,349; 7,008,564; 7,282,295; 7,282,296; 7,282,302; 7,285,362; 7,390,591; 7,491,458; 7,608,178; 7,645,543; 7,666,233; 7,691,289; 7,704,468; 7,781,108; 7,829,212; 7,838,144; 7,858,223; 7,864,397; 7,998,626; 8,048,571; 8,114,171; 8,182,943; 8,202,649; 8,293,398; 8,323,820; 8,334,075; 8,361,664; 8,389,147; 8,455,131; 8,459,213; 8,501,339; 8,529,867; 8,652,686; 8,652,692; 8,658,304; 8,671,684; 8,673,477; 8,709,679; 8,778,522; 8,828,573; 8,828,574; 8,828,575; 8,916,291; 8,932,771; 8,980,602; 8,986,638; 9,051,629; 9,061,261; 9,123,941; 9,136,568; 9,187,834; 9,187,835; 9,190,695; 9,200,375; 9,206,210; 9,257,720; 9,269,998; 9,287,573; and Patent Appl. Nos. 20040009404; 20050255385; 20080096056; 20100094042; 20120088162; 20130089793; 20130259776; 20140140912; 20140342240; 20150340739; each of which is expressly incorporated herein by reference in its entirety.

In one embodiment, the PA/Pz solvent mixture includes the addition of an inorganic MP compound to further improve (reduce) the viscosity and ionic conductivity (increase) of the solvent mixture without adversely impacting the mixture's volatility, flammability, and thermal stability. At operating temperatures of 0° C.-50° C., the MP is typically provided, whereas in case of high temperature operation, the viscosity of the PA and Pz may be sufficiently low to permit efficient operation without the MP. This addition makes the solvent an ideal electrolyte for high discharge rate battery applications. Further, due to the greatly increased electrochemical window of stability versus organic systems, the use of high energy electrode couples is provided. Numerous examples of these couples exist, but are not in current use due to the limitations of the traditionally used organic electrolyte systems.

There are well documented inherent limitations in current lithium-ion battery technologies. Some of these limitations arise from the organic electrolyte solvents due to their volatility, flammability, and thermal and electrochemical instability as they pertain to bulk electrolyte solution and the SEI. According to the present technology, the organic electrolyte solvents may be replaced with an all-inorganic electrolyte solvent system. “All-inorganic” is not intended to exclude organic substituents on inorganic core molecules. For example, 95% or greater by weight of the solvent may comprise phosphorus-containing compounds, and preferably 98% or greater by weight. Small amounts of other components are acceptable, so long as they do not greatly increase the vapor pressure or flammability of the composite.

In a preferred embodiment, the electrolyte solvent system is composed solely of phosphorus-compounds as a mixture of primary solvent PA derivatives and co-solvent Pz derivatives with a suitable supporting salt, i.e., a supporting lithium salt, in the case of a lithium battery. In addition, an inorganic MP compound can be added to this mixture, for example to further improve the solvent's capacity to work for high discharge applications without impacting the other benefits of the PA/Pz mixtures. In battery usage, the solvent system should solvate the charge carrier ion, i.e., a metal ion, to permit charge carrier densities of at least 0.1M, more preferably 0.5M, and most preferably greater than 1.0M. Further, in battery usage, the solvated charge carrier ions should not be tightly complexed to the solvent, and therefore the effective charge carrier ion should be the metal ion itself and not a solvent-molecule bound metal ion. In some cases, a minor portion of the electrolyte may bind charge carriers, especially if a source of charge carriers is provided in excess with respect to the complex-forming component. Further, while the solvent system is preferably non-reactive with the static battery chemistry, is preferably has a sufficient level of reactivity with the electrodes during battery cycling to form an SEI to effectively isolate the bulk electrolyte from the electrode surface, while permitting ion mobility through the SEI to the electrodes. Useful characteristics of the electrolyte are lack of flammability in air at standard temperature and pressure, low vapor pressure at 30° C. (e.g., less than 50 mBar, preferably less than 10 mBar, more preferably less than 5 mBar, and most preferably less than 1 mBar, all at 25° C.), low viscosity at 30° C. (≤30 cp), low toxicity (or reasonable method for detoxification), and an efficient biodegradation pathway at the end of the useful life.

Other types of batteries than lithium may be provided, such as sodium, potassium, aluminum, magnesium, manganese, vanadium, and the like. In such cases, the supporting salt and appropriate electrodes will of course correspond to the battery chemistry. In some cases, the solvent is not an electrolyte, or is provided as a potential electrolyte solvent prior to addition of a charge carrier. The solvent finds particular application in energy storage devices.

As used herein, the term “energy storage device” means and includes a device configured and comprising materials formulated to convert stored chemical energy into electrical energy or electrical energy into chemical energy. The energy storage device may include, but is not limited to, a battery or a capacitor. By way of example only, the energy storage device may be a metal-ion battery, a metal battery (e.g., Li, Na, K, Mg, Mn, V, etc.), an ultracapacitor, or a supercapacitor. In the case of capacitive energy storage systems, the formation of an SEI is not critical.

The pendant groups on the PA compound may be selected based on desired properties of the PA compound, such as to achieve sufficient stability, viscosity, flammability, salt solubility, ion transport, and cell cyclability properties of the PA compound to be used as the electrolyte or in the electrolyte solution. A desired balance of these properties may be achieved by appropriately selecting the pendant groups. The PA compound may be tailored to exhibit a low viscosity at room temperature, stability with respect to the electrochemical system chemistry (e.g., toward lithium or other metal, e.g., a high lithium or sodium salt, or other alkali metal, alkaline earth metal, transitional metal, or post transition metal salt) solubility, stability at high voltage, low flammability, and low volatility by appropriately selecting the pendant groups. The viscosity of the PA compound may be directly proportional to the molecular weight of the PA compound, which is, in turn, affected by the molecular weight of the pendant groups. By minimizing the molecular weight of the pendant groups, the PA compound may exhibit a viscosity within the desired range. To achieve the desired viscosity, the pendant groups may be selected to produce an asymmetric PA compound, i.e., a PA compound having different substituents on the phosphorus atom, which is believed to minimize molecular scale ordering and discourage a high extent of solvent self-association, aggressive multi-dentate bridging with an ionic species, and the generation of ordered or crystalline structures. Note that the viscosity of the mixed-component solvent is not directly related to the viscosity of the respective components, but as a first approximation, a lower viscosity of a significant solution component will yield a lower viscosity aggregate solution. Note also that addition of the supporting salt to the aggregate solution may also alter the viscosity.

The phosphorus substituents may also be selected such that the PA compound does not easily conform to solvate cations past mono-dentate coordination, including electron withdrawing moieties, such as fluorine. The PA compound may also be formulated in the electrolyte solution with dissimilar compounds to avoid solvent-to-solvent molecular association. These properties may directly impact the charge transfer process in the energy storage device where ions need to be able to readily associate and de-associate with solvent members through ion solvation, which has thermodynamic and kinetic costs in terms of energy and time requirements. Thus, selecting the pendant groups to achieve lower viscosity of the PA compound may additionally make the energy storage device more efficient by economizing charge transfer at each electrode interface. If, however, the PA compound is to be used as an additive in the electrolyte solution, the viscosity may be greater than the range described below to account for mixture effects with the electrolyte solution. The pendant groups may also be selected to provide the PA compound with sufficient electrochemical stability for use in the electrochemical environment of the energy storage device.

The pendant groups may also be selected such that the PA compound has a supporting salt solubility of at least about 1.0 M concentration at room temperature. If, however, the PA compound is to be used as an additive in the electrolyte solution, the salt solubility may be less than the above-mentioned concentration to account for mixture effects with the electrolyte solution. The salt solubility of the PA compound may also be improved by interactions with other components of the electrolyte solution. However, the PA compound may still have the ability to desolvate from the supporting salt cations to enable adequate cycling efficiencies and allow acceptable rate capabilities.

The pendant groups on the PA compound may be selected such that the PA compound is a liquid at room temperature (from about 20° C. to about 25° C.) and at the temperature of use, e.g., 0° C. or below to 60° C. or above, is stable at a temperature greater than about 150° C., and is substantially non-flammable at operating temperatures to which the electrolyte solution is exposed, e.g., ≤65° C. The PA compound of the electrolyte solution may also be stable at high voltages, such as greater than about 4.5 V, during cycling of the energy storage device including the electrolyte solution. The pendant groups on the PA compound may be selected such that the PA compound has an increased flash point and a decreased flame duration as compared to organic electrolytes, resulting in reduced flammability of the electrolyte solution.

The melting point of the PA compound may be in a range of from about −30° C. to about 10° C. so that the PA compound is a liquid at room temperature and at the temperature of use. Note that the PA compound is a component of the electrolyte solution, and therefore the melting point of the PA compound alone is not dispositive. Since the PA compound is to be used in the energy storage device, such as a battery, the temperature of use may be within a range of from about −25° C. to about 150° C. To maintain the PA compound as a liquid, the pendant groups may include at least one of a fluorinated alkyl group, an aryl group, the organosilyl group, an oxygen-containing organic group, and a branched organic group on the nitrogen atom, and different R groups (R¹, R², R³) may be used on the phosphorus atom. By selecting the X group from these functional groups, crystal packing may be disrupted so that the PA compound may remain a liquid at room temperature.

A phosphine oxide functional group bonded to the nitrogen atom of the PA compound, i.e., X is [—P(═O)R₂], may be avoided because the P═O bond is strongly attracted to lithium ions.

The term “alkyl” means and includes a saturated, unsaturated, straight, branched, or cyclic hydrocarbon containing from one carbon atom to ten carbon atoms. Examples include, but are not limited to, methyl, ethyl, propyl(n-propyl, isopropyl, cyclopropyl), butyl(n-butyl, isobutyl, sec-butyl, tert-butyl, cyclobutyl), pentyl(n-pentyl, tert-pentyl, neopentyl, isopentyl, sec-pentyl, 3-pentyl, cyclopentyl), hexyl(isohexyl, cyclohexyl, 3-methylpentyl, 2,2-dimethylbutyl, 2,3-dimethylbutyl), heptyl, octyl, nonyl, or decyl. The term “alkoxy” means and includes an alkyl group linked to an oxygen atom. The alkoxy group may include, but is not limited to, a methoxy group, an ethoxy group, a propoxy group, a butoxy group, a pentoxy group, a hexoxy group, a heptoxy group, an octoxy group, a nonoxy group, or a decoxy group, or an alkoxy-substituted alkoxy group (i.e., a polyether group), such as a methoxy methoxy group, a methoxy ethoxy group, an ethoxy methoxy, an ethoxy ethoxy group, a methoxy ethoxy ethoxy group, etc. The term “aryl” means and includes a hydrocarbon with alternating single and double bonds between carbon atoms forming a ring. Examples include, but are not limited to, a phenyl group, a tolyl group, or a naphthyl group. The aryl group may also contain a heteroatom, such as sulfur (thiophene, benzothiophene, etc.), oxygen (furan, benzofuran, etc.), or nitrogen (pyrrole, indole, pyridine, pyrimidine, imidazole, pyrazole, etc.). The term “aryloxy” means and includes an aryl group linked to an oxygen atom. In addition to the oxygen-containing groups (i.e., alkoxy, aryloxy) mentioned above, functional groups including other heteroatoms, such as sulfur or nitrogen, may be present in the pendant group. The heteroatom may link, for example, the alkyl group or the aryl group to the phosphorus atom of the PA compound. By way of example only, the sulfur or nitrogen analogue may include, but is not limited to, an alkylsulfide, an alkylamine, an arylsulfide, or an arylamine. The term “organosilyl” means and includes a compound having at least one carbon-silicon bond. At least one of an alkyl group, an alkoxy group, an aryl group, an aryloxy group, or a halogen group may be bonded to the silicon atom. The groups bonded to the silicon atom may be the same as, or different from, one another. The alkyl group may be further substituted, such as with a halogen. The aryl group may be further substituted, such as with a halogen, an alkyl group, or a haloalkyl group. By way of example only, the organosilyl may be a trialkylsilyl group. The term “halo” or “halogen” means and includes fluoro, chloro, bromo, or iodo. Any of the above-mentioned functional groups may be further substituted with at least one substituent, such as with a halogen, a carboxyl, a carbonyl, a C(O)(alkyl), a carbonate, another keto functional group, an amine, an alkyl, an alkoxy, an alkylthio, an amide, an alkylamino, a dialkylamino, a haloalkyl, a hydroxyalkyl, an alkoxyalkyl, a cyano, a sulfonyl group, or a phosphate group. The cationic pendant group may include, but is not limited to, an ionic form of an aromatic amine, an aryl amine, or an aliphatic amine, such as a nitrogen-containing aryl group, a primary amine, a secondary amine, or a tertiary amine. The aromatic amine may be an aniline group. The nitrogen-containing aryl group may include, but is not limited to, a pyrrole group, an imidazole, a pyrazole, a pyridine group, a pyrazine group, a pyrimidine group, or a pyridazine group. By way of example, the amine group may be a methyl amino group or a dimethyl amino group.

The viscosity of the PA compound alone, or the solvent solution as a whole, may be within a range of from about 1 centipoise (cP) (about 0.001 Pas) to about 30 cP (about 0.03 Pas) at 20° C. or 30° C. or 35° C., such as from about 1 cP (about 0.001 Pas) to less than or equal to about 10 cP (about 0.01 Pas) at 20° C. or 30° C. or 35° C. or from about 1 cP (about 0.001 Pas) to less than or equal to about 7 cP (about 0.007 Pas) at 20° C. or 30° C. or 35° C.

The MP compound, if provided may be a simple organophosphates, organophosphonates, organophosphinates, and/or organic phosphine oxide alkyl and/or aryl derivative. Organophosphates are fully esterified derivatives of phosphoric acid and are conveniently synthesized employing light aliphatic or aryl alcohols. Organophosphates are widely employed both in natural and synthetic applications because of the case with which organic groups can be linked together. Organic phosphine oxides are similar in structure to the organophosphates, except they contain direct phosphorus-carbon linkages, instead of being bound through a heteroatom, like oxygen. Organophosphonates and organophosphinates have both ester and phosphorus-carbon linkages. These compounds are also readily synthesized, for example as a by-product of the Wittig reaction. Another common route to phosphine oxides is the thermolysis of phosphonium hydroxides. As in the case with the organophosphates, the R-groups may be any light aliphatic or aryl group, and most preferred is for each molecule to have a plurality of differing groups attached to the same central phosphorus.

The metal salt may be a salt of lithium, sodium, potassium, magnesium, manganese, or other alkali metal or alkaline earth metal, or vanadium, or other metals. The solvent solution as a whole, may have a high salt solubility, such as from about 0.1 to 5 M, and for example, may be 0.5 M to about 1.2 M, or 0.8 to 1.1 M, in a solution of a metal salt, such as in a lithium salt solution, a sodium salt solution, other alkali metal solution, alkaline earth metal solution, transitional metal solution, or post transition metal solution. By way of example only, the lithium salt may be lithium hexafluorophosphate (LiPF₆), lithium tetrafluoroborate (LiBF₄), lithium perchlorate (LiClO₄), or combinations thereof. The solvent solution with a 1.0 M supporting salt at room temperature may have a conductivity of at least about 5 mS/cm.

The solvent system may provide a good ion cyclability in the energy storage device, such as at least a C/1 equivalent cycling rate. However, when used in consumer electronics, the battery including the solvent may exhibit a lower cycling rate.

The various compounds according to the present technology are produced according to standard techniques, and may be available as commodity products.

The electrolyte solution including the PA compound may be used in an energy storage device (e.g., a battery or capacitor) that includes a positive electrode (e.g., a cathode), a negative electrode (e.g., an anode) separated from the positive electrode, and an optional separator between the electrodes, with an SEI layer forming at a surface of the electrodes. The electrolyte solution is in contact with the positive electrode and the negative electrode, but may be positioned in the separator. By way of example, the energy storage device may be a lithium battery containing the electrolyte solution.

It is therefore an object to provide an electrolyte solvent formulation comprising: a phosphoranimine; a phosphazene; and optionally a monomeric phosphorus compound. The formulation preferably has a melting point below 0° C. The formulation preferably has a vapor pressure of combustible components at 60.6° C. sufficiently low to not produce a combustible mixture in air (the “flash point”), e.g., a vapor pressure of less than 40 mmHg at 30° C. The phosphoranimine, phosphazene, and monomeric phosphorus compounds preferably has no direct halogen-phosphorus bonds.

It is a still further object to provide an electrolyte solvent formulation comprising: a phosphoranimine; and a phosphazene; having a melting point below 0° C., and a vapor pressure of combustible components at 60.6° C. sufficiently low to not produce a combustible mixture in air, wherein none of the phosphoranimine and phosphazene compounds has any direct halogen-phosphorus bonds.

The formulation preferably comprises a supporting salt having a concentration of at least 0.1M charge carrier ions. The supporting salt, may comprise a supporting lithium salt effective to render the electrolyte solvent formulation suitable for use as an electrolyte in a lithium-ion battery, e.g., LiPF₆.

The monomeric phosphorus compound may comprise a phosphate, phosphonate, phosphinate, or phosphine. The MP preferably has at least two different types of pendent groups. The monomeric phosphorus compound may comprise an organophosphate compound in an amount sufficient to achieve a viscosity of the formulation of less than about 30 cp at 35° C.

The monomeric phosphorus compound may be present in an amount of between 10% and 50% by volume.

The phosphoranimine typically has the structure: X—N═P(R¹, R², R³), wherein X, R¹, R², and R³ are independently selected from the group consisting of inorganic and organic functional groups, wherein R¹, R², and R³ are represented by at least two different substituents. X may be selected from the group consisting of an organosilyl group and a tert-butyl group. R¹, R², and R³ may be independently selected from the group consisting of an alkoxy group, and an aryloxy group.

The phosphazene may comprise a plurality of phosphazenes having respectively different pendent group substitution. The phosphazene may comprise a substituted phosphazene having substituents selected from the group consisting of alkoxy and fluorinated alkoxy groups. The substituted phosphazene may comprise at least one of an ethoxy substituent and a 2,2,2-trifluoroethoxy substituent. The phosphazene may be present in an amount of between 0.1% and 50% by volume, and preferably in an amount of between 10% and 20% by volume.

The formulation preferably comprises less than about 2% by weight of organic compounds consisting essentially of at least one of carbon, hydrogen, and oxygen.

The phosphoranimine is preferably present in an amount of between 20-50% by volume, the phosphazene is preferably present in an amount of between 3-15% by volume, and the monomeric phosphorus compound is preferably present in an amount of 20-50% by volume.

The formulation may be provided with a battery or other energy storage device, having an anode, a cathode, a separator, and a supporting salt.

In a battery, a solid electrode interphase layer consisting essentially of breakdown products of at least one of the phosphoranimine, the phosphazene, and the monomeric phosphorus compound forms near the electrodes.

It is another object to provide an electrolyte for use in a lithium battery, which is liquid at 0° C., comprising a supporting lithium salt, and a solvent comprising less than about 2% purely organic compounds consisting essentially of carbon, hydrogen and oxygen. The electrolyte preferably has a vapor pressure of less than 40 mmHg at 30° C. The electrolyte may be provided in combination with: an anode, a cathode, and a separator configured to separate the anode and the cathode and permit lithium-ion permeability there-through. A solid electrolyte interphase layer selectively forms near a surface of the anode and cathode from degradation products of the electrolyte. The formed solid electrolyte interphase layer is preferably stable for at least 245 days at 60° C. The electrolyte preferably comprises a phosphoranimine, a phosphazene, optionally a monomeric phosphorus compound, and the supporting lithium salt. The solid electrolyte interface layer formed by the electrolyte with the electrodes is more preferably thermally stable ≥80° C. At least one of the phosphoranimine and the phosphazene may comprise a plurality of different phosphoranimines or different phosphazenes having a plurality of respectfully different substituents.

The electrolyte preferably comprises between 0.1% and 50% of the phosphazene by volume and between 10% and 20% of the phosphazene by volume. The electrolyte optionally comprises the up to 50% by volume of the monomeric phosphorus compound.

A further object provides a rechargeable lithium-ion battery, comprising an anode, a cathode, a separator, an electrolyte, a supporting lithium salt, and a solid electrolyte interphase layer, the electrolyte comprising at least one phosphoranimine, at least one cyclic phosphazene, and at least one organophosphate, wherein the electrolyte has a viscosity of ≤30 cp at 35° C., a concentration of lithium ions of at least 0.2M, and a vapor pressure of ≤40 mmHg at 30° C., wherein the solid electrolyte interphase layer is formed by degradation of the electrolyte in proximity to the cathode and the anode and is stable against degradation at 65° C.

It is further object to provide a lithium-ion battery having an operating temperature range which extends beyond 0° C. to 50° C., and has an electrolyte viscosity of less than 30 cp within the operating temperature range.

It is another object to provide a method of forming a battery, comprising: providing an anode, a cathode, a separator, and a electrolyte solvent formulation comprising: a phosphoranimine, a phosphazene; and a supporting salt, the solvent formulation having a melting point below 0° C., and a vapor pressure of combustible components at 60.6° C. sufficiently low to not produce a combustible mixture in air, wherein none of the phosphoranimine, and phosphazene has any direct halogen-phosphorus bonds; and cycling the battery at to form a solid electrolyte interface formed from products of the phosphoranimine and phosphazene. The electrolyte solvent may further comprise a monomeric phosphorus compound, e.g., a, organophosphate. The electrolyte solvent formulation preferably has a viscosity of less than about 30 cp at 35° C.

### BRIEF DESCRIPTION OF THE DRAWINGS

FIG. 1 is the basic chemical structure of the primary phosphoranimine from which other derivatives may be derived by replacement of X, R¹, R², and R³ with various function groups as described within the claims herein.

FIG. 2 is the example chemical structure of the co-solvent phosphazene, in this example, an embodiment using ethoxy and 2,2,2-trifluoroethoxy functional groups.

FIG. 3 shows the benefits of low levels of FM2 (˜10%) on battery performance.

FIG. 4 shows that the presence of FM2 in SEI layer is beneficial to the battery.

### DETAILED DESCRIPTION OF THE INVENTION

The PA and Pz compounds are considered inorganic compounds due to their phosphorus-nitrogen (P═N) parent structure. The MP component is considered inorganic due to the core P atom in the parent structure as the primary atom that substituent atoms or molecules are bonded as defined by IUPAC.

The technology involves the preparation of a totally inorganic electrolyte which may have application in lithium-ion batteries. It employs an admixture of a lower molecular weight phosphorus-based compounds, from the class of molecules known as the PAs as the principal solvent and a higher molecular weight phosphorus-based compound, from the class of molecules known as the Pzs as a co-solvent, as well as a suitable supporting salt (such as LiPF₆, etc.) to formulate the novel electrolyte. This particular combination of substances obviates the well-known safety and longevity problems associated with current organic-based technologies, while offering numerous other benefits to battery reliability and performance. An MP compound may be provided which, e.g., serves as a viscosity reducer for the solution.

Compared to other organophosphorous compounds and other additives, Pzs showed the least degradation in battery performance. A key performance consideration is ionic conductivity of the solvent. The rate of ion transfer is influenced by the ionic conductivity of the electrolyte solvent. The conductivity itself is generally inversely proportional to the viscosity of the solvent—a less viscous fluid will transfer lithium ions more readily. Carbonates and other organic electrolyte solvents are generally well known to be good ionic conductors due to their low viscosity. However, they break down easily at elevated temperatures, as low as 50° C., which can easily be experienced during normal battery operation. This creates residue within the electrolyte that reduces the ionic conductivity, increases the viscosity, and potentially leads to runaway thermal events. The PA/Pz solvent mixture in this invention is designed to be a suitable carrier of lithium ions while improving the battery's safety and longevity.

PA possess the requisite high lithium salt solubility and low viscosity while Pz offer benefits to the electrochemical performance and formulation stability required to realize the next generation of lithium-ion batteries. Taken together, this new electrolyte formulation allows for a totally inorganic electrolyte system, superior to current technologies. The Pz co-solvent maintains the high lithium salt solubility and introduces the beneficial properties of significantly improved electrochemical and thermal stability, leading to increased performance. The Pz component has been shown to increase the width of the electrochemical window—the range of voltages where there are no redox reactions occurring in the electrolyte—improving the durability of the battery over a larger range of voltages. As described in Rollins, H. W., Harrup, M. K., Dufek, E. J., Jamison, D. K., Sazhin, S. V., Gering, K. L., & Daubaras, D. L., “Fluorinated Phosphazene Co-solvents for Improved Thermal and Safety Performance in Lithium-ion Battery Electrolytes”, Journal of Power Sources, 263, 66-74 (2014), expressly incorporated herein by reference in its entirety, electrolyte solutions of 20% Pz with carbonates extends the electrochemical window up to 1.85V over the baseline 0.85 V window exhibited by carbonate solutions alone. This beneficial trend is should continue for PA/Pz mixtures and PA/Pz/MP mixtures. See also E. J. Dufek, M. L. Stone, D. K. Jamison, F. F. Stewart, K. L. Gering, L. M. Petkovic, A. D. Wilson, M. K. Harrup, H. W. Rollins, “Hybrid Phosphazene Anodes for Energy Storage Applications”, J. of Power Sources, 267 (2014) 347-355; and E. J. Dufek, J. R. Klaehn, H. W. Rollins, M. K. Harrup, D. Jamison, “Phosphoranimine-based Battery Electrolytes”, J. of Power Sources, pending (2014), each of which is expressly incorporated herein by reference in its entirety.

Both PA and Pz, as well as MP, have very low thermal degradation rates compared to pure carbonate electrolytes. Pz alone can act as a “free-radical sponge” when used in carbonate electrolytes to slow their thermal degradation. In Rollins et al (2015) supra, solutions containing only organic carbonate electrolytes completely degrade after about 55 days of being held at 60° C., leaving a black solid residue. Solutions containing both organic carbonate and quantities of Pz retained much of the carbonate through 245 days held at the same temperature, and only showed slight discoloration. Pz as a co-solvent with PA would be expected to further diminish the effects of degradation of the solvent in this invention.

Both solvents have lower vapor pressures than that of typical organic solvents including but not limited to ethylene carbonate, ethyl methyl carbonate, and diethyl carbonate. PA and Pz are well-known for their flame retardant properties and possess high thermal stability. These features provide lower volatility, lower flammability and greater thermal stability than current organic lithium-ion battery solvents.

An MP compound, for example a simple alkyl or aryl derivative of phosphate ((R′O)—(R″O)—(R″′O)—P═O) or phosphine oxide (R′R″R″′P═O), or organophosphonate ((R′O)—(R″O)—(R″′)—P═O) or ((R′O)—(R″)—(R″′)—P═O) is provided. The R groups R′, R″, R″′ may be the same or different, for example an alkyl group, an aryl group, an alkoxy group, or an aryloxy group, or a sulfur or nitrogen analogue thereof. These groups may be substituted with halogens, but the MP compound, like the PA and Pz, should lack direct phosphorus-halogen bonds, and all should lack hydroxyl groups. The substituents preferably are different, to reduce packing and suppress the melting point of the MP compound and the electrolyte as a whole. For example, the MP compound may be methanoyl, ethanoyl, isopropanoyl phosphate.

The all-inorganic PA/Pz solvent mixture (optionally including MP) will also improve the stability of the SEI layer. The SEI layer forms during battery charging as a result of the irreversible decomposition of the electrolyte at the surface of the electrode, creating a thin solid layer on the electrode. Once formed, the SEI layer isolates the electrode surface from the bulk solvent as the SEI layer does not readily allow diffusion of free solvent to the electrode surface, preventing further decomposition, and possesses low electrical conductivity. The SEI still allows for case of lithium ion intercalation to the surface of the electrode to allow for continued battery operation.

The SEI layer will primarily be generated over the first few charging cycles averaging between 100 nm and 1 micron once fully formed. In typical carbonate solvents, the layer will grow slowly through additional cycles through further solvent decomposition that competes with the lithium intercalation, contributing to capacity fade over large number of cycles. The SEI stability is temperature-sensitive, and as the battery heats up as through normal use, the SEI will break down into the electrolyte and re-expose the electrode. The electrode will then readily react with fresh solvent to reform this layer, consuming more of the lithium ions and furthering the capacity fade. The SEI decomposition reaction is also exothermic and can lead to thermal runaway if not controlled. The SEI layers formed from carbonate-based solvents will break down at a relatively low temperature, as low as 55° C., which can easily be realized in typical lithium batteries.

The use of an electrolyte solvent mixture of primary PA solvent and the Pz co-solvent, and optionally MP, improves the stability of the SEI layer. Both PA and Pz have been separately evaluated with organic carbonate-based solvents. Battery cells using PA or Pz mixed with organic carbonate solvents show lower capacity fade compared to organic carbonate-only solvents, indicating that the SEI layer where PA or Pz is present is much more stable than in organic carbonate-only solutions. The solvent mixture will improve stability of the SEI layer as compared to an SEI layer in a carbonate-based battery and be much more stable under high charge/discharge rates.

Another benefit that the PA/PZ solvent mixture (optionally with MP) has in regards to the SEI layer is in improving the ionic conductivity of the SEI layer due to Pz. Battery cells using organic carbonate solutions have been evaluated via impedance spectroscopy with and without the addition of Pz. The impedance of the SEI layer is reduced when Pz is present in the electrolyte solvent, as well as retaining the higher stability described above. This would make it easier to transfer charge through the layer, allowing for faster discharge rates.

The syntheses of the individual constituents are herein described in detail as a means of non-limiting example.

### MP Compound Synthetic Pathway

The MP compounds are preferably simple alkyl and/or aryl derivatives of organophosphates and/or organic phosphine oxides and/or organic phosphonates. Organophosphates are widely employed both in natural and synthetic applications because of the ease with which organic groups can be linked together. Organophosphates are conveniently synthesized employing light aliphatic or aryl alcohols according to the general reaction scheme given below:

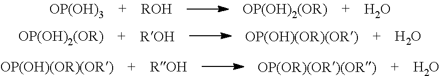

Organophosphinates and phosphonates are phosphate derivatives having one or two phosphorus-carbon bonds, respectively, with the remaining phosphorus bonds being oxygen/ester bonds. They may be prepared, for example, using an Arbuzov sequence or Michaelis-Arbuzov rearrangement, Abramov reaction, Pudovik reaction, Michaelis-Becker reaction, etc., from a corresponding phosphate. See Richardson, Rebekah Marie, New Synthesis and Reactions of Phosphonates, Doctoral Dissertation, U. of Iowa (2012), expressly incorporated herein by reference in its entirety.

Organic phosphine oxides are similar in structure to the organophosphates, except they contain only direct phosphorus-carbon linkages, instead of being bound through a heteroatom, like oxygen. These compounds are also readily synthesized through the two general reaction schemes shown below:

Phosphine oxides are frequently generated as a by-product of the Wittig reaction:

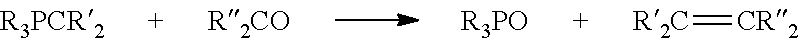

Another common route to phosphine oxides is the thermolysis of phosphonium hydroxides. In the laboratory, phosphine oxides are usually generated by the oxidation, often accidentally, of tertiary phosphines: R₃P+½O₂→R₃PO

As in the case with the organophosphates, the R-groups may be any light aliphatic or aryl group, and most preferred is for each molecule to have a plurality of differing groups attached to the same central phosphorus.

### PA Synthetic Pathway

The synthesis of PAs for this purpose was accomplished using the established Neilson and Wisian-Neilson methods. The synthetic route includes the preparation an initial aminophosphine which is then oxidized to the corresponding PA using elemental bromine. Maximization of LiPF₆ solubility was accomplished by substituting the subsequent bromine group(s) on the P^{V} center with various alkyl and etheric oxygen-containing pendant groups. Pz synthetic pathway:

In an oven dried 500 ml flask, 50 g (0.144 moles) of the hexachlorocyclotriphosphazene trimer was dissolved in ˜300 ml anhydrous dioxane which was then added to the a solution of sodium ethoxide (under nitrogen at room temperature) and heated at sub-reflux for 5 hours and the reaction progress was monitored by ³¹P NMR. This solution was then cooled to room temperature and then added to a solution of sodium trifluoroethoxide (at RT under nitrogen). This solution was heated to sub reflux for ˜5 hours. This reaction was also followed by ³¹P NMR. When the reaction was complete, the solution was allowed to cool to room temperature and the excess ethoxides were quenched with water. The solution was neutralized with 2 M HCl. The solvent was removed by rotary evaporation leaving the Pz product (a liquid) and undissolved solid sodium chloride. The product separated from the salt by decantation and taken up in dichloromethane and washed with nanopure (18 MΩ cm) water in a separatory funnel six times to remove trace impurities. The dichloromethane was removed from the product on a rotary evaporator and the product was then dried in an argon purged vacuum oven for several days, refreshing the atmosphere with fresh UHP argon daily.

Although both classes of phosphorus compounds have been previously investigated individually, this work has been founded on the use of these compounds individually in combination with traditional organic carbonate-based solvents in an attempt to reduce the shortcomings of use of these solvents. According to the present technology, organic carbonates are generally excluded as a substantial component of the formulation altogether, to form a new all-inorganic electrolyte. For example, <2% of the solvent is organic carbonates. This electrolyte is compatible with most known lithium-ion battery components in widespread use today. These include the anode, the cathode, electrode binders, and the mechanical separator, as well as common casing components. As such, the overall processes and key materials for the commercial manufacture of lithium-ion batteries are unaltered from current methodologies. The embodiment of this invention is a lithium-ion based battery system that uses an electrolyte mixture of one or more PA components as the primary solvent, and one or more Pz components as the co-solvent. In the preferred embodiment, the mixture is composed primarily of one or more PA components (that is, Pz components comprising less than 50% of the solvent by volume). In a more preferred embodiment, the Pz components are present in the range of 10 to 20% by volume.

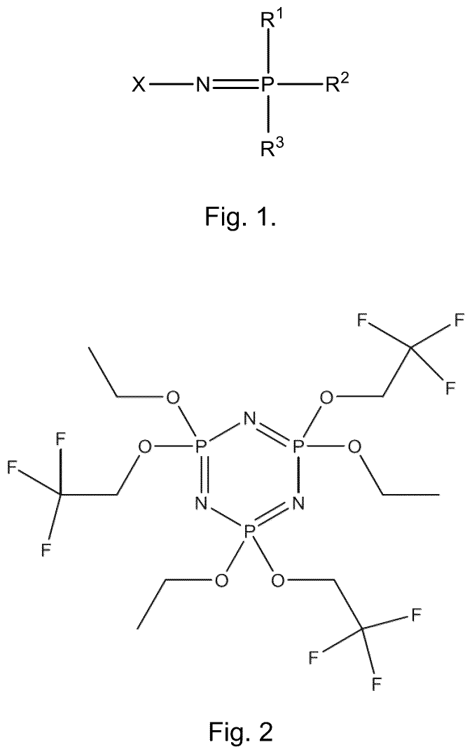

US Patent Application No. 20150340739 describes an embodiment of the PA. In the preferred embodiment, the PA includes at least one PA compound which has the chemical structure as shown in FIG. 1, where X is an organosilyl group or a tert-butyl group and each of R¹, R², and R³ is independently selected from the group consisting of an alkyl group, an aryl group, an alkoxy group, or an aryloxy group. In another embodiment, each of R¹, R², and R³ is independently selected from a cationic pendant group, which includes but is not limited to an ionic form of an aromatic amine, an aryl amine, or an aliphatic amine, such as a nitrogen containing aryl group, a primary amine, a secondary amine, or a tertiary amine. The aromatic amine may be an aniline group. The nitrogen containing aryl group may include, but is not limited to, a pyrrole group, an imidazole, a pyrazole, a pyridine group, a pyrazine group, a pyrimidine group, or a pyridazine group. The PA compound, or mixture thereof, is designed to meet desired properties for lithium-ion batteries, including low viscosity, high ionic conductivity, low vapor pressure, and non-flammability

In the embodiment, the Pz mixture includes at least one cyclic Pz compound, having a 6-membered alternating P—N ring structure, and with each phosphorus atom having 2 constituent functional groups attached to it. An example is shown in FIG. 2. In a more preferred embodiment, these functional groups include a combination of alkoxy and fluorinated alkoxy groups, as described in Rollins, Harry W., Mason K. Harrup, Eric J. Dufek, David K. Jamison, Sergiy V. Sazhin, Kevin L. Gering, and Dayna L. Daubaras. “Fluorinated phosphazene co-solvents for improved thermal and safety performance in lithium-ion battery electrolytes.” Journal of Power Sources 263 (2014): 66-74, expressly incorporated herein by reference in its entirety. One example of this preferred embodiment, is where these groups are, respectively, ethoxy (CH₃—CH₂—O—) and 2,2,2-trifluoroethoxy (CF₃—CH₂—O—).

In some embodiments, inorganic MP compounds are added for the purpose of further lowering the viscosity of the PA/Pz electrolyte mixture, while enhancing ionic conductivity. This is done to address some energy storage applications that demand a very fast charge/discharge rate (typically >3 C). The purpose for the selection of these inorganic-based compounds is three-fold. First, it maintains the all-inorganic nature of the electrolyte blend as previously asserted in this application. Second, one of the areas where PA and Pz compounds decompose into MP species is during the formation of the SEI layer during battery operation. As such, addition of these compounds will not adversely affect the SEI composition over a pure PA/Pz formulation, while retaining all of the desired beneficial electrical and physical properties inherent in the PA/Pz mixture. Third, these compounds are known to have a lower viscosity than either PA or Pz alone, achieving a total lower viscosity for the electrolyte formulation. In a preferred embodiment, the MP compounds will be present up to 20% by volume in the PA/Pz mixture.

### EXAMPLE

A model of a lithium-ion battery using the mixture of PA and Pz were developed based on existing data on the characterization and testing of PA and Pz components, specifically referred to as PA2 and FM2, respectively. Parameters for the model using an equivalent circuit model were determined from data regression of impedance testing of FM2 in electrolyte mixtures, and from physical property values for viscosity and conductivity for PA2 and FM2 determined through experiment. The model used physical property relationships to project the performance of a battery that used only a mixture of PA2 and FM2. This model estimates the hydrodynamic and electrochemical properties of the PA2/FM2 electrolyte solvent and the battery performance using established property correlations for chemical mixtures. These relationships are based on standard trends for normal molecular interactions between compounds. Non-normal behavior can be exhibited in certain circumstances, but does not negate the novelty of this invention. The SEI was modeled from the results of the FM2 experimental data and is shown below for a range of compositions (from 0% to 100% FM2) to gauge the estimated range of performance.

The model was used to calculate the performance of a lithium-ion battery using various mixtures of PA2/FM2 (from 100% to 50% PA) at discharge rates from 1/10 C to 10 C. The following table is the voltage of a single battery cell at various state-of-charge (SOC) levels as a function of the battery electrolyte composition, the anticipated SEI layer composition, and the discharge rate.

TABLE 1
Estimated Battery Voltage during Discharge for Various PA2/FM2 Configurations

| | | Discharge Rate | | | | | | | | | | | |
|---|---|---|---|---|---|---|---|---|---|---|---|---|---|
| | FM2 | 1/10 C Discharge | | | 1 C Discharge | | | 3 C Discharge | | | 10 C Discharge | | |
| Solvent | in SEI | SOC | | | | | | | | | | | |
| Comp. | Layer | 90% | 60% | 20% | 90% | 60% | 20% | 90% | 60% | 20% | 90% | 60% | 20% |
| 0% | 0% | 4.0470 | 3.8459 | 3.7030 | 3.7046 | 3.5027 | 3.3600 | 2.9419 | 2.7400 | 2.5970 | 0.0273 | 0.0707 | 0.0700 |
| FM2 | | | | | | | | | | | | | |
| 10% | 0% | 4.0525 | 3.8506 | 3.7080 | 3.7512 | 3.5500 | 3.4079 | 3.0841 | 2.8822 | 2.7392 | 0.7465 | 0.5445 | 0.4015 |
| FM2 | | | | | | | | | | | | | |
| | 50% | 4.0583 | 3.8564 | 3.7134 | 3.8096 | 3.6077 | 3.4647 | 3.2570 | 3.0551 | 2.9191 | 1.3230 | 1.1210 | 0.9780 |
| | 100% | 4.0602 | 3.8582 | 3.7146 | 3.8281 | 3.6262 | 3.4832 | 3.3126 | 3.1106 | 2.9676 | 1.5080 | 1.3060 | 1.1630 |
| 25% | 0% | 4.0575 | 3.8555 | 3.7119 | 3.8011 | 3.5992 | 3.4562 | 3.2315 | 3.0296 | 2.8866 | 1.2378 | 1.3059 | 0.8929 |
| FM2 | | | | | | | | | | | | | |
| | 50% | 4.0632 | 3.8613 | 3.7183 | 3.8588 | 3.6568 | 3.5138 | 3.4045 | 3.2025 | 3.0595 | 1.8143 | 1.6123 | 1.4693 |
| | 100% | 4.0651 | 3.8631 | 3.7202 | 3.8773 | 3.6753 | 3.5324 | 3.4600 | 3.2580 | 3.1150 | 1.9993 | 1.7974 | 1.6544 |
| 35% | 0% | 4.0603 | 3.8584 | 3.7154 | 3.8294 | 3.6275 | 3.4845 | 3.3164 | 3.1145 | 2.9715 | 1.5029 | 1.3190 | 1.1760 |
| FM2 | | | | | | | | | | | | | |
| | 50% | 4.0660 | 3.8641 | 3.7211 | 3.8871 | 3.6851 | 3.5422 | 3.4894 | 3.2874 | 3.1444 | 2.0974 | 1.8954 | 1.7524 |
| | 100% | 4.0679 | 3.8660 | 3.7230 | 3.9056 | 3.7037 | 3.5607 | 3.5441 | 3.3429 | 3.1999 | 2.2824 | 2.0805 | 1.9375 |
| 50% | 0% | 4.0638 | 3.8619 | 3.7189 | 3.8650 | 3.6622 | 3.5200 | 3.4230 | 3.2211 | 3.0785 | 1.8762 | 1.6743 | 1.5313 |
| FM2 | | | | | | | | | | | | | |
| | 50% | 4.0696 | 3.8677 | 3.7247 | 3.9226 | 3.7207 | 3.5777 | 3.5960 | 3.3940 | 3.2510 | 2.4527 | 2.2507 | 2.1077 |
| | 100% | 4.0715 | 3.8695 | 3.7270 | 3.9411 | 3.7392 | 3.5966 | 3.6515 | 3.4495 | 3.3065 | 2.6377 | 2.4358 | 2.2928 |

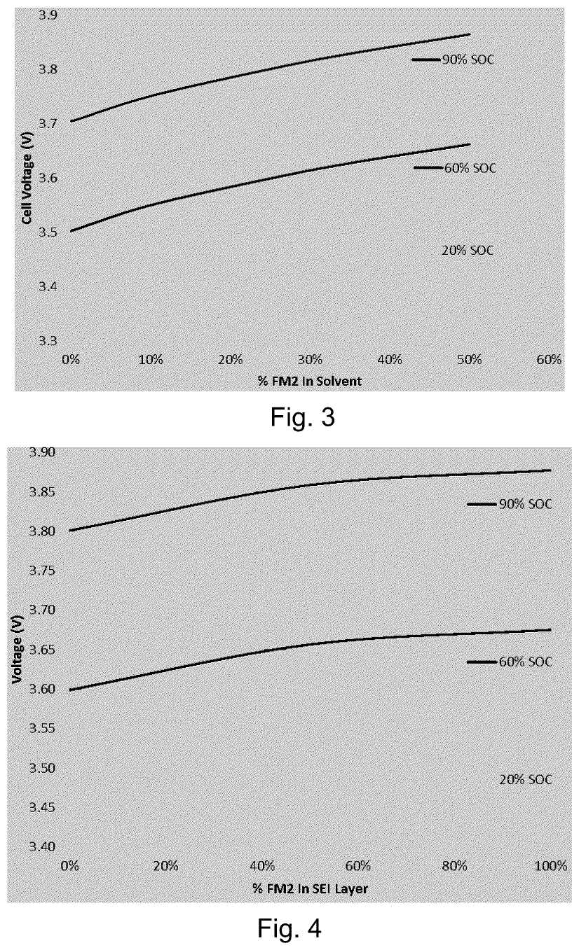

Actual data shows that the base PA2 solvent will have a sufficiently low viscosity and corresponding high ionic conductivity to make it a suitable electrolyte in lithium battery applications at low discharge rates, when salted to a relevant level with a typical lithium salt, such as LiPF₆. Using this data, the model shows that pure PA2 viscosity may not be sufficient as a pure solvent for high discharge rates (greater than 3 C). Addition of FM2 will increase the electrolyte thermal and electrochemical stability and can reduce the impedance of the solvent, improving the battery's performance. From this model, the benefit is apparent with low levels of FM2 (˜10%) and suggests diminishing returns at higher levels. FIG. 3 shows this influence. The model does not presently include the influence of MP compounds, which are expected to further depress the solution's viscosity without altering the other benefits of the PA2/FM2 (PA/Pz) mixture. The performance of batteries using the PA2/FM2/MP compounds would be expected to be better than what is shown in this model results for PA2/FM2 alone.

Similarly, the presence of FM2 in SEI layer is beneficial to the battery, as it appears the material offers lower resistance to ionic transfer to the electrodes, as shown in FIG. 4. Only a small amount of FM2 is required to achieve this, FM2 was added to carbonate solvents; additional FM2 beyond 50% within the SEI layer appears to have diminishing returns.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof. The scope of the disclosure is intended to encompass all combinations, subcombinations, and permutations of the various disclosures herein (regardless of whether in multiple-dependent format), and unless specifically limited by the claims, no particular aspect is considered essential. Likewise, the invention comprises materials and methods that facilitate production of an end product and portions of the end product. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

What is claimed is:

1. A battery, comprising:
a metal anode;
an electrolyte comprising a cyclic phosphazene;
a cathode;
a metal salt; and
a dynamic solid electrolyte interface layer on the metal anode comprising breakdown products of the cyclic phosphazene, wherein the solid electrolyte interface layer is adapted to break down and reform on the metal anode from battery cycling.

2. The battery according to claim 1, wherein the metal anode is a lithium metal anode, the metal salt comprises a lithium salt, and the cathode comprises a lithium ion intercalation cathode material.

3. The battery according to claim 1, wherein the electrolyte further comprises an organic solvent.

4. The battery according to claim 1, wherein the electrolyte further comprises an organic carbonate.

5. The battery according to claim 1, wherein the electrolyte further comprises a phosphoranimine.

6. The battery according to claim 1, wherein the metal salt achieves a charge carrier density in the electrolyte of at least 0.1M.

7. The battery according to claim 1, wherein the metal salt comprises LiPF₆.

8. The battery according to claim 1, wherein the electrolyte lacks direct halogen-phosphorus bonds.

9. The battery according to claim 1, wherein the cyclic phosphazene comprises substituents selected from the group consisting of alkoxy and fluorinated alkoxy groups.

10. The battery according to claim 1, wherein the cyclic phosphazene comprises at least one of an ethoxy substituent and a 2,2,2-trifluoroethoxy substituent.

11. The battery according to claim 1, where the cyclic phosphazene is present in an amount of between 20-50% by volume of the electrolyte.

12. A battery, comprising:
a lithium metal anode;
an electrolyte comprising a cyclic phosphazene; and
a solid electrolyte interface layer dynamically formed and reformed on the lithium metal anode during cycling of the battery comprising breakdown products of the cyclic phosphazene.

13. The battery according to claim 12, further comprising a lithium ion intercalation cathode.

14. The battery according to claim 13, wherein the electrolyte further comprises an organic carbonate.

15. The battery according to claim 14, wherein the cyclic phosphazene comprises substituents selected from the group consisting of alkoxy and fluorinated alkoxy groups.

16. The battery according to claim 12, wherein the cyclic phosphazene comprises at least one of an ethoxy substituent and a 2,2,2-trifluoroethoxy substituent.

17. The battery according to claim 12, where the cyclic phosphazene is present in an amount of between 20-50% by volume of the electrolyte.

18. A method of forming a battery, comprising:
providing a metal anode, an electrolyte comprising a cyclic phosphazene, a cathode, and a supporting salt;
forming a solid electrolyte interface layer on the metal anode comprising breakdown products of the cyclic phosphazene; and
breaking down and reforming the solid electrolyte interface layer on the metal anode during cycling of the battery,
wherein the solid electrolyte interface layer acts as an efficient free radical quencher, and provides an effective barrier that protects the bulk electrolyte from continuous degradation.

19. The method according to claim 18, wherein the metal anode is a lithium metal anode, the supporting salt comprises a lithium salt, and the cathode comprises a lithium ion intercalation cathode material.

20. The method according to claim 19, wherein the electrolyte further comprises an organic carbonate.
